(19) United States
(12) Patent Application Publication
(10) Pub. No.: US 2020/0129793 A1
(43) Pub. Date: Apr. 30, 2020

(54) FOLDABLE RIM ASSEMBLY FOR AN AERIAL FIRE-FIGHTING BUCKET

(71) Applicant: AERIAL FIRE CONTROL INTERNATIONAL PTY LTD, Hahndorf (AU)

(72) Inventor: Christopher Herbert BLACK, Hahndorf (AU)

(21) Appl. No.: 16/670,192

(22) Filed: Oct. 31, 2019

(30) Foreign Application Priority Data
Oct. 31, 2018 (AU) 2018904126

(51) Int. Cl. A62C 3/02; B64D 1/16

(52) U.S. Cl. CPC A62C 3/0235; B64D 1/16

(57) ABSTRACT

A foldable rim assembly for an aerial fire-fighting bucket, the bucket including a collapsible body, the body having an upper rim surrounding an open upper end of the body, the rim assembly including;
a) a plurality of spokes about a central hub, the spokes extending radially outwardly from the hub, each outer end of a spoke being pivotably connectable to the upper rim of the body, and each inner end of a spoke being pivotably connected to the hub; and
b) at least one spoke locking member which is engageable when the spokes are deployed to lock the inner ends of the spokes with the hub in an uppermost position and the body expanded;
   wherein, in use, when the at least one spoke locking member is disengaged, the hub is movable to a lowermost position, with the spokes folded and the body collapsed.

### TECHNICAL FIELD

The present invention relates to foldable rim assemblies for use with collapsible, aerial fire-fighting buckets of the type suspended below an aircraft. Typically, such an aircraft would be a helicopter.

### BACKGROUND OF INVENTION

Large fires or fires in remote locations are often fought using aircraft to drop chemical fire retardants or water either directly on the fire or at nearby locations to create a fire break. Helicopters are often used for such operations because they do not require a dedicated landing strip and more importantly because they can fill their fire-fighting bucket without the need to land the helicopter. Typically, the bucket can be filled at a nearby body of water which may include a lake, dam, river or even a swimming pool. Having the ability to fill the bucket in this way reduces the time between water drops, hopefully resulting in the fire being extinguished more quickly. Filling the bucket locally also saves fuel and other running costs which can be extremely expensive.

U.S. Pat. Nos. 5,560,429 and 5,829,809 both describe aerial fire-fighting buckets which permit dumping of one or more separate loads of water for a single fill of the bucket. Each bucket utilises at least one dump valve in the form of a flexible sleeve, together with significant rigging and lines to control the operation of the valves and also to create and maintain the form and shape of the collapsible buckets.

These US patents both describe the preferred use of “rim openers” of the “hub and spoke” type instead of the use of a rim stiffened merely by a plurality of circumferentially extending battens inserted in circumferentially extending sleeves passing around the rim. This prior art stiffening technique is said by both US patents to have been unduly time consuming when preparing the buckets for either storage or deployment, hence the adoption in the US patents of the hub and spoke rim openers mentioned above.

However, as is clearly evident from the figures in both US patents, the hub and spoke rim openers illustrated both require further rigging for their operation and provide no support for the open upper end of the buckets when the buckets are not in use or are being prepared for deployment or for storage. At those times, the buckets still tend to collapse inwardly, making them difficult and time consuming to handle.

The present invention seeks to provide an improved rim assembly for use with a collapsible, aerial fire-fighting bucket.

Before turning to a summary of the present invention, it is to be appreciated that various directional terms, such as upper, lower, upwardly, vertical, bottom and the like, have been used throughout this specification to provide context and clarity for the invention with reference to its normal upright use when a fire-fighting bucket is slung below a helicopter with its discharge opening lowermost for the purpose of allowing liquid to flow therefrom downwardly under the force of gravity. These terms are not to be taken as limiting the invention to use only in one particular orientation.

The discussion of the background to the invention herein is included to explain the context of the invention. This is not to be taken as an admission that any of the material referred to was published, known or part of the common general knowledge as at the priority date of this application.

### SUMMARY OF INVENTION

The present invention provides a foldable rim assembly for an aerial fire-fighting bucket, the bucket including a collapsible body, the body having an upper rim surrounding an open upper end of the body, the rim assembly including:
a) a plurality of spokes about a central hub, the spokes extending radially outwardly from the hub, each outer end of a spoke being pivotably connectable to the upper rim of the body, and each inner end of a spoke being pivotably connected to the hub; and
b) at least one spoke locking member which is engageable when the spokes are deployed to lock the inner ends of the spokes with the hub in an uppermost position and the body expanded;
   wherein, in use, when the at least one spoke locking member is disengaged, the hub is movable to a lowermost position, with the spokes folded and the body collapsed.

The hub and spoke arrangement of the foldable rim assembly of course includes the central hub, which may be formed in one piece or from multiple parts, and the radially outwardly extending spokes. In one form, the hub is generally disc-shaped with an advantageously low profile provided for the hub by a flat and circular (and ideally thin) shape, such that when the spokes are deployed and the hub is locked in its uppermost position by the spoke locking member(s), the hub and the spokes are generally co-planar and approximately level with the upper rim.

The preferred co-planar configuration for the hub and spoke arrangement when deployed and locked is advantageous for the stability of the bucket both when loaded and when empty, and also for minimising mechanical stress on the hub and spokes. For example, allowing the bucket body to collapse and lose its laminar shape creates flight issues during use, especially when the bucket is empty, as the folds on the outer extremity of a bucket can catch the wind and can make a bucket rotate and behave erratically in forward flight. Prior art designs have relied on cables and chains to keep their hub and spoke systems level relative to the top of the bucket, but those cables and chains only tend to take full effect when a bucket is full.

Also, if such cables and chains are not set properly for a pre-set payload, such hub and spoke systems can be either too high or too low relative to the upper rim of a bucket, causing undue stress on the hub and spoke system, to the point where either the spokes might break or the adjustment cables and chains might snap, or the actual payload may be reduced by collapse of the bucket rim and thus the sidewall of the bucket. The upper rim assembly of the present invention, particularly with the preferred co-planar configuration mentioned above for the hub and spoke arrangement, avoids any irregular shape of the bucket body when either full or empty, and advantageously keeps a uniform loading on the hub and spoke arrangement at all times

In a preferred form of the present invention, the spoke locking members are associated with the central hub. This reference to “associated with” means that the spoke locking members are ideally integral with the central hub in that they form a part of the hub and/or the inner ends of the spokes that are pivotably connected to the hub, as opposed to being a part of the outer rim of the body or a part of the system used for supporting the bucket under an aircraft. In this form, a simple and central locking and deploying system can be adopted to improve the speed and efficiency of setting up the bucket, and to provide for a strong and stable bucket body.

In one form, one spoke locking member can be provided for each of the spokes, each spoke locking member being associated with the hub at or near where the inner end of a respective spoke is pivotably connected to the hub. Such spoke locking members might for example be rotatable latches connected to the hub adjacent to a spoke's pivotable connection, each latch capable of being rotated into and out of locking engagement with its respective spoke to prevent the spoke from pivoting.

In this form, individual manipulation of each latch would be required, which for some users might be undesirable. Therefore, in a more preferred form, a single spoke locking member may be provided that is capable of interacting with the inner ends of all spokes at the same time to provide the engagement and disengagement referred to above. Manipulation of just this single spoke locking member then serves to lock and unlock all spokes at once, providing for even faster and easier set up of the bucket.

Where just a single spoke-locking member is provided, capable of interacting with the inner ends of all spokes at the same time, the central hub may be provided as a dual plate central hub, having upper and lower hub plates. In this form, the lower hub plate is ideally fixed, and includes the pivotable connection to the inner ends of the spokes, such that the inner ends of the spokes can be positioned between the plates. The upper hub plate on the other hand is rotatable relative to the lower hub plate, to allow for movement of the upper hub plate into and out of positions where the inner ends of the spokes are either locked in the deployed position or are unlocked and in the folded position. In this form, the upper rotatable plate becomes a single spoke-locking member, although it functions as such together with the lower plate. This is an example of the spoke locking member(s) being associated with the central hub, as foreshadowed above.

With regard to movement of the spokes from the deployed position to the folded position, such movement will occur in conjunction with:
1) the unlocking of the spoke locking member(s), which in the above preferred form occurs with the rotation in a first direction of the upper hub plate relative to the fixed lower hub plate;
2) then the folding of the spokes, and the collapsing of the body of the bucket with the lowering of the hub to its lowermost position; and
3) optionally, the subsequent locking of the spoke locking member(s) with the hub in its lowermost position, with the spokes folded and the body of the bucket collapsed.

With regard to the reverse movement of the spokes from the folded position to the deployed position, such movement will occur in conjunction with:
1) the unlocking of the spoke locking member(s) (if the hub is locked in its lowermost position);
2) then the unfolding and deployment of the spokes, and the expansion of the body of the bucket, with the raising of the hub to its uppermost position; and
3) the subsequent locking of the spoke inner hinges with the hub in its uppermost position, which in the above preferred form occurs with the rotation in the opposite direction of the upper hub plate relative to the fixed lower hub plate, with the spokes deployed and the body of the bucket expanded.

In a preferred version of the dual plate central hub mentioned above, the upper rotatable plate can include a plurality of radial slots about the periphery of the upper plate, opening at the outer edge of the plate and configured to pass completely through the thickness of the plate, each slot positionable above the inner end of a respective spoke, and being sized so as to be capable of receiving the inner end of a spoke when folded. In this position, the spokes may be folded and unfolded, with their inner ends moving into and out of a respective slot, such that the hub can move from its uppermost position to its lowermost position (with the body thus moving from expanded to collapsed), during that folding movement.

In this form, when the upper plate is rotated to move the slots away from the spokes, the inner ends of the spokes are caught between the upper and lower plates and are held in their deployed position, which in this version of the central hub renders the hub and the spokes held so as to be generally co-planar.

The central hub may additionally be provided with a means of locking the upper rotatable plate in a position where the spokes are deployed. In a simple form, this may be provided by a clamp or some form of fastening device.

In a further preferred version of the dual plate central hub, the upper rotatable plate can include a second slot in the form of a circumferential slot that preferably extends for a short distance about the periphery of the plate reasonably close to the outer edge. Thus, in this form, the upper rotatable plate includes a plurality of slot pairs spaced equally thereabout, each slot pair being for engagement with an inner end of a respective spoke, the slot pairs including the radial slots and the circumferential slots already mentioned.

In this preferred version, each circumferential slot is also configured to pass completely through the thickness of the plate, so as to be capable of receiving a respective lockable guide pin extending upwardly from the lower plate. The interaction of a lockable guide pin in a circumferential slot is preferably such as to hold the upper plate adjacent to the lower plate, with the inner ends of the spokes therebetween, and to guide and permit rotation of the upper plate relative to the lower plate. This rotation allows movement of the inner ends of the spokes into and out of alignment with a respective radial slot of the upper plate to permit the above described folding movement of the spokes. Each lockable guide pin is preferably also able to be locked in any position in a respective circumferential slot so as to lock the upper plate relative to the lower plate and thus lock the spokes either in their deployed or folded positions.

### BRIEF DESCRIPTION OF DRAWINGS

Having briefly described the general concepts involved with the present invention, a preferred embodiment of a foldable rim assembly will now be described that is in accordance with the present invention. However, it is to be understood that the following description is not to limit the generality of the above description.

In the drawings:

FIG. 1 is a perspective view from above of a collapsible, aerial fire-fighting bucket having a foldable rim assembly in accordance with a preferred embodiment of the present invention, the assembly being shown with its spokes deployed, its central hub in its uppermost position and generally co-planar with the spokes and the upper rim of the bucket body, and with the bucket body expanded;

FIG. 2 is a schematic side view of the embodiment of FIG. 1, showing the spokes folded, the central hub in its lowermost position, and the bucket body collapsed;

FIG. 3 is an exploded perspective view of a disassembled two part central hub of the embodiment of FIG. 1;

FIG. 4 is an exploded perspective view of the central hub of FIG. 3 when assembled and with the spokes deployed; and

FIG. 5 is an exploded perspective view of the central hub of FIG. 3 when assembled and with the spokes folded.

### DETAILED DESCRIPTION OF PREFERRED EMBODIMENT

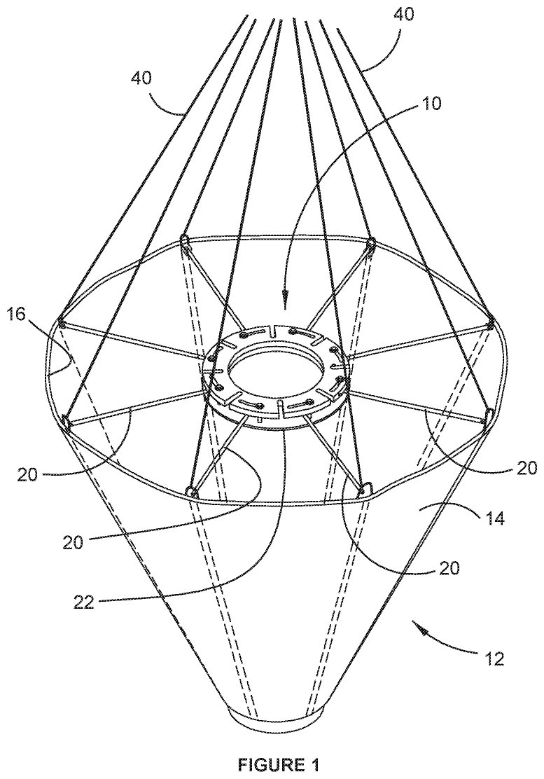

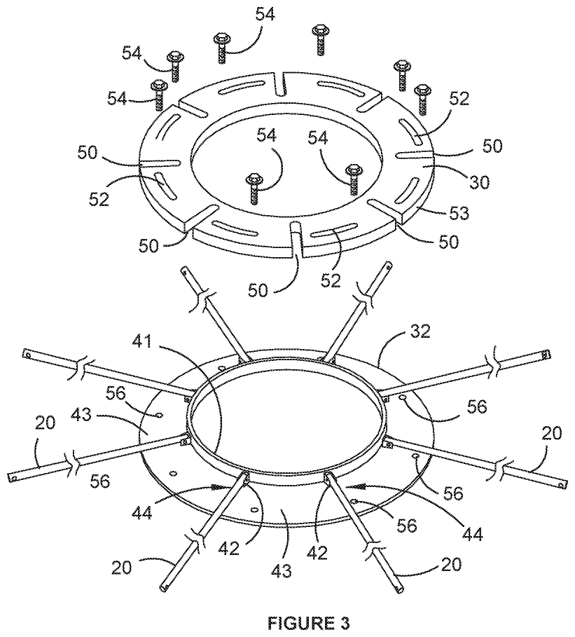

Illustrated in FIG. 1 is a foldable rim assembly 10 for an aerial fire-fighting bucket 12, the bucket 12 including a collapsible body 14 having an upper rim 16 surrounding an open upper end of the body 14. Also evident in FIG. 1, although visible in more detail in FIGS. 3 to 5 (as described below), is a hub and spoke assembly that includes a plurality of spokes 20 about a central hub 22. The spokes 20 extend radially outwardly from the hub 22, with each outer end of a spoke 20 being pivotably connected to the upper rim 16 of the body 14, and each inner end of a spoke 20 being pivotably connected to the hub 22.

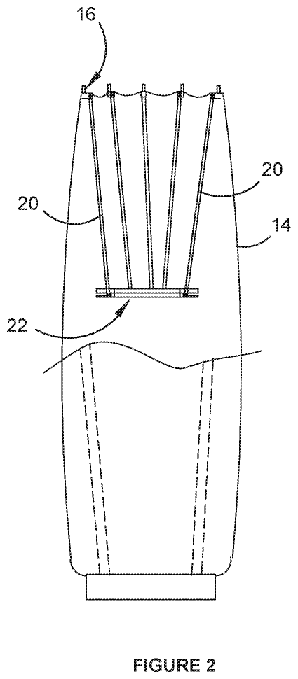

The rim assembly 10 is shown in FIG. 1 with its spokes 20 deployed, its central hub 22 in its uppermost position, and with the bucket body 14 expanded and ready for use. In contrast, in FIG. 2, the spokes 20 are shown folded, the central hub 22 is in its lowermost position, and the bucket body 14 is shown collapsed.

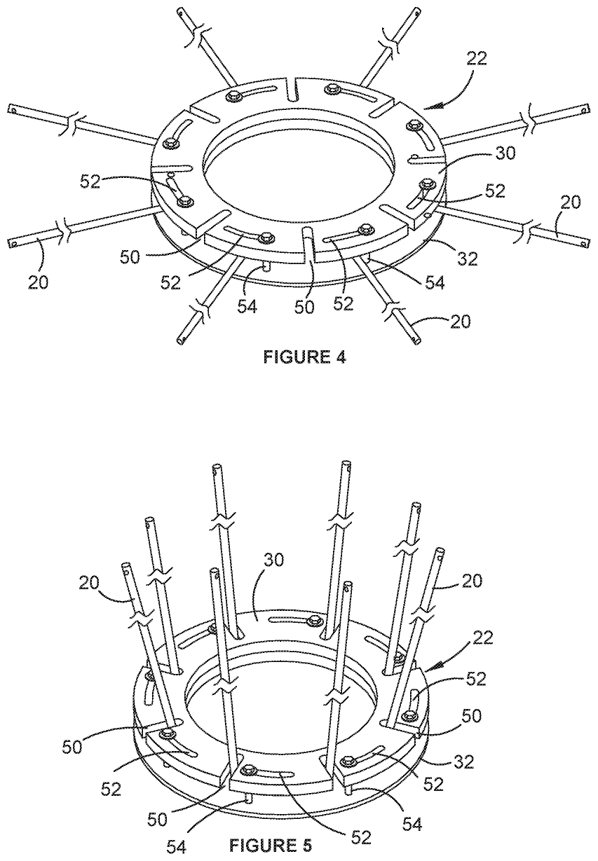

A preferred form of foldable rim assembly 10 will now be described in relation to FIGS. 3 to 5. In this embodiment, the central hub 22 is formed in two parts, being upper and lower hub plates 30 and 32, both of which are annular and generally disc-shaped, providing the central hub 22 with its advantageously low profile such that when the spokes 20 are deployed (FIGS. 1 and 4) and the hub 22 is locked in its uppermost position, the hub 22 and the spokes 20 are generally co-planar and approximately level with the upper rim 16.

In this embodiment, the upper hub plate 30 forms a spoke locking member in combination with the lower hub plate 32. The spoke locking member is thus associated with the central hub 22, forming a part of the central hub 22, as opposed to being formed as a part of the rim 16 or the cable system 40 (shown in FIG. 1) used to suspend the bucket 12 below an aircraft (not shown).

The lower hub plate 32 is fixed in that it cannot rotate about its longitudinal axis relative to the spokes 20, and includes pivotable connections 42 in the form of spigots (preferably stainless steel spigots) at the upright flange 41 to the inner ends 44 of the spokes 20. In this form, the inner ends 44 of the spokes 20 rest upon the lateral flange 43 of the lower hub plate 32, preventing downward movement of the spokes 20 beyond that level, but the spokes 20 are obviously able to pivot upwardly away from the lower flange 43 to a vertically upright position.

The upper hub plate 30 on the other hand is configured so as to be rotatable relative to the lower hub plate 32, to allow for movement of the upper hub plate 30 into and out of positions where the inner ends 44 of the spokes 20 are either locked in the deployed position (FIG. 4) or are unlocked and in the folded position (FIG. 5). The upper rotatable plate 30 thus becomes a single spoke-locking member, able to lock all spokes 20 at the same time, although it functions as such together with the lower plate 32.

The outer ends of the spokes 20 attach with the same type of spigot used at the inner ends of the spokes 20, namely a solid stainless steel spigot. The outer ends may be set between the inner faces of two vertical brackets (not shown) bolted through the rim 16 of the bucket 12, with backing plates (not shown) for support and compressive attachment via multiple bolts to the bucket 12, spreading the load across a larger surface area. In this form, the two brackets and the spigot have a similar horizontal aperture therethrough to accept the pin of a stainless steel shackle to which each rigging line 40 may be attached,

The upper rotatable plate 30 includes a plurality of radial slots 50 about the periphery of the upper plate 30, opening at the outer edge 53 of the plate 30, extending inwardly towards the central axis of the plate 30, and passing completely through the thickness of the plate 30. Each of the radial slots 50 are positionable above the inner end 44 of a respective spoke 20 with rotation of the upper plate 30, as illustrated in FIG. 5, to permit the folding of the spokes 20 upwardly for the collapse of the bucket body 14, being sized so as to be capable of receiving the inner end 44 of a spoke 20 when folded. In this position (FIG. 5), the spokes 20 may be folded and unfolded, with their inner ends 44 moving into and out of a respective slot 50, such that the central hub 22 can move from its uppermost position (FIG. 1) to its lowermost position (FIG. 2), with the body 14 thus moving from expanded to collapsed, during that folding movement.

In this respect, and with regard to FIG. 2, it will be noted that the radial slots 50 extend far enough inwardly to permit the spokes 20 to fold upwardly slightly past vertical, permitting the folded spokes 20 to over-centre slightly towards the centre of the hub, ensuring that the bucket can be stowed as small as possible for loading inside a helicopter.

When the upper plate 30 is rotated to move the slots 50 away from the spokes 20, such as movement from the configuration in FIG. 5 to the configuration in FIG. 4, the inner ends 44 of the spokes 20 are held between the upper and lower plates 30,32 and are held in their deployed position (FIG. 4), which renders the hub 22 and the spokes 20 held so as to be generally co-planar (FIG. 4).

The central hub 22 also includes a means of locking the upper rotatable plate 30 in position when the spokes 20 are deployed, which in the illustrated embodiment sees the upper rotatable plate 30 having a plurality of second slot in the form of circumferential slots 52 that extends for a short distance about the periphery of the plate 30 reasonably close to the outer edge 53. Thus, the upper rotatable plate 30 can be seen to include a plurality of slot pairs 50,52 spaced equally thereabout, each slot pair 50,52 being for engagement with an inner end 44 of a respective spoke 20, the slot pairs 50,52 including the radial slots 50 and the circumferential slots 52.

Each circumferential slot 52 is again configured to pass completely through the thickness of the plate 30, so as to be capable of receiving a respective lockable guide pin 54 extending upwardly from the lower plate 32. The interaction of a lockable guide pin 54 in a circumferential slot 52 is such as to hold the upper plate 30 adjacent to the lower plate 32, with the inner ends 44 of the spokes 20 therebetween, and to guide and permit rotation of the upper plate 30 relative to the lower plate 32. This rotation allows movement of the inner ends 44 of the spokes 20 into and out of alignment with a respective radial slot 50 of the upper plate 30 to permit the following folding movement of the spokes 20, In this respect, each lockable guide pin 54, here shown in the form of a simple nut and bolt arrangement, passing through suitably sized holes 56 in the lower plate 32, is of course also able to be locked in any position in a respective circumferential slot 52 so as to lock the upper plate 30 relative to the lower plate 32 and thus lock the spokes 20 either in their deployed or folded positions.

With regard to movement of the spokes 20 from the deployed position (FIG. 4) to the folded position (FIG. 5), such movement will occur in conjunction with:
1) the unlocking of the lockable guide pins 54, followed by rotation in a first direction of the upper hub plate 30 relative to the fixed lower hub plate 32 until the inner ends 44 of the spokes 20 align with respective radial slots 50;
2) then the folding of the spokes 20 to their vertical position (FIG. 5), and the collapsing of the body 14 of the bucket with the lowering of the central hub 22 to its lowermost position; and
3) the subsequent locking of the lockable guide pins 54 with the hub 22 in its lowermost position, with the spokes 20 folded and the body 14 of the bucket collapsed (FIG. 5).

With regard to the reverse movement of the spokes 20 from the folded position to the deployed position, such movement will occur in conjunction with:
1) the unlocking of the lockable guide pins 54;
2) then the unfolding and deployment of the spokes 20, and the expansion of the body 14 of the bucket, with the raising of the hub 22 to its uppermost position (FIG. 4); and
3) the subsequent locking of the lockable guide pins 54 with the hub 22 in its uppermost position (FIG. 4), which occurs with the rotation in the opposite direction of the upper hub plate 30 relative to the fixed lower hub plate 32, with the spokes 20 deployed and the body 14 of the bucket expanded.

As can be seen, when in their deployed position (FIG. 4), the spokes 20 are clamped between the upper hub plate 30 and the lateral flange 43 of the lower hub plate 32, providing a rigid and strong hub and spoke arrangement. Ideally the spokes 20 and the upper hub plate 32 will be made of a composite material to provide strength yet save weight, and to avoid corrosion through electrolysis, with stainless steel bolts being used for the lockable guide pins 54 and the lower hub plate 30. However, it will be appreciated that any suitable material, or combination of materials, may be used for the spokes 20, such as using a hollow metal sleeve with a composite fibre internal reinforcing shaft.

The spokes 20 ideally have a rectangular cross-section and are pivotably connected to the lower hub plate 32 and the rim 16 on their narrow edges, again to assist with providing strength and rigidity.

Finally, it will be appreciated that it may be desirable to add the upper surface of the upper hub plate 30 one or more handles or knobs or the like to assist with rotation of the upper plate 30 and the deployment of the hub and spoke arrangement. This will allow an operator to keep hands away from pinch points and to more easily actuate the hub and spoke arrangement.

In conclusion, it must be appreciated that there may be other variations and modifications to the configurations described herein which are also within the scope of the present invention.

1. A foldable rim assembly for an aerial fire-fighting bucket, the bucket including a collapsible body, the body having an upper rim surrounding an open upper end of the body, the rim assembly including:
a) a plurality of spokes about a central hub, the spokes extending radially outwardly from the hub, each outer end of a spoke being pivotably connectable to the upper rim of the body, and each inner end of a spoke being pivotably connected to the hub; and
b) at least one spoke locking member which is engageable when the spokes are deployed to lock the inner ends of the spokes with the hub in an uppermost position and the body expanded;
wherein, in use, when the at least one spoke locking member is disengaged, the hub is movable to a lowermost position, with the spokes folded and the body collapsed.

2. A foldable rim assembly according to claim 1, wherein the hub is generally disc-shaped, such that when the spokes are deployed and the hub is locked in its uppermost position by the spoke locking member(s), the hub and the spokes are generally co-planar and approximately level with the upper rim.

3. A foldable rim assembly according to claim 1, wherein the spoke locking members are associated with the central hub.

4. A foldable rim assembly according to claim 1, wherein a single spoke locking member is provided that is capable of interacting with the inner ends of all spokes at the same time to provide the engagement and disengagement.

5. A foldable rim assembly according to claim 4, wherein the central hub is a dual plate central hub, having upper and lower hub plates.

6. A foldable rim assembly according to claim 5, wherein the lower hub plate is fixed, and includes pivotable connection to the inner ends of the spokes, such that the inner ends of the spokes can be positioned between the plates

7. A foldable rim assembly according to claim 5, wherein the upper hub plate is rotatable relative to the lower hub plate, to allow for movement of the upper hub plate into and out of positions where the inner ends of the spokes are either locked in the deployed position or are unlocked and in the folded position.

8. A foldable rim assembly according to claim 5, wherein the upper rotatable plate includes a plurality of radial slots about the periphery of the upper plate, opening at the outer edge of the plate and configured to pass completely through the thickness of the plate, each slot positionable above the inner end of a respective spoke, and being sized so as to be capable of receiving the inner end of a spoke when folded

9. A foldable rim assembly according to claim 8, wherein when the upper plate is rotated to move the radial slots away from the spokes, the inner ends of the spokes are caught between the upper and lower plates and are held in their deployed position, which renders the hub and the spokes held so as to be generally co-planar

10. A foldable rim assembly according to claim 8, wherein the central hub includes a means of locking the upper rotatable plate in a position where the spokes are deployed.

11. A foldable rim assembly according to claim 8, wherein the upper rotatable plate includes a plurality of circumferential slots that each extend for a short distance about the periphery of the plate reasonably close to its outer edge.

12. A foldable rim assembly according to claim 11, wherein each circumferential slot is configured to pass completely through the thickness of the plate, so as to be capable of receiving a respective lockable guide pin extending upwardly from the lower plate.

13. A foldable rim assembly according to claim 12, wherein the interaction of a lockable guide pin in a circumferential slot is preferably such as to hold the upper plate adjacent to the lower plate, with the inner ends of the spokes therebetween, and to guide and permit rotation of the upper plate relative to the lower plate.

14. A foldable rim assembly according to claim 13, wherein each lockable guide pin is able to be locked in any position in a respective circumferential slot so as to lock the upper plate relative to the lower plate and thus lock the spokes either in their deployed or folded positions.

15. A foldable rim assembly according to claim 8, wherein the upper rotatable plate includes a plurality of slot pairs spaced equally thereabout, each slot pair being for engagement with an inner end of a respective spoke, the slot pairs including the radial slots and the circumferential slots.
